(19) United States
(12) Patent Application Publication
(10) Pub. No.: US 2014/0070017 A1
(43) Pub. Date: Mar. 13, 2014

(54) Spray gun for the application of dual component media and use of the spray gun to apply adhesives

(71) Applicants: Goetz HILLERT, Pirmasens (DE); Martin SCHAEFER, Godramstein (DE); Alfred MELKA, Charlotte, NC (US)

(72) Inventors: Goetz HILLERT, Pirmasens (DE); Martin SCHAEFER, Godramstein (DE); Alfred MELKA, Charlotte, NC (US)

(73) Assignee: WAKOL GMBH, Pirmasens (DE)

(21) Appl. No.: 13/609,682

(22) Filed: Sep. 11, 2012

(51) Int. Cl. B05B 7/04

(52) U.S. Cl. CPC B05B 7/0483
USPC 239/8; 239/408; 239/1

(57) ABSTRACT

A spray gun to apply dual component media has a gun housing with an application nozzle, a mixing system for combining the components and a material channel in the gun housing for introducing the first component into the mixing system, a needle shut-off mechanism sliding along its longitudinal axis and guided in the gun housing, at least one reagent channel in the needle shut-off mechanism to introduce the second component into the mixing system and/or into the material channel, at least one outlet opening arranged in the reagent channel away from the longitudinal axis to release the second component from the reagent channel, at least one control device to slide the needle shut-off mechanism inside the gun housing, and at least one metering device to alter the cross-section of the at least one outlet opening.

### PRIOR ART

The invention is based on a spray gun for the application of dual component media with a mixing system in the gun housing for combining the components.

Sprayable media such as coatings, sealants, paints and adhesives are often based on organic solvents. The solvents are needed to impart a suitable viscosity to the medium in order to permit its application by spraying. Solvents with a low boiling point are often used to achieve swift drying. This results in harmful solvents such as toluene, cycloalkanes and ethyl acetate being released into the ambient air as the medium dries.

For ecological and health reasons, there is consequently a growing need for water-based media. In particular dual component media based on an aqueous dispersion where a coating or bonding medium is chemically modified through the use of an activator or catalyst are able to satisfy a wide range of requirements depending on the area of application. Here, the activator or catalyst is added to the medium and prompts activation or hardening, for example.

In the area of bonding technology, as high an initial adhesion as possible is required immediately after application of the adhesive. This requirement is met in particular by shear-sensitive water-based adhesives with a polymer dispersion basis. Chloroprene dispersions represent a particularly suitable category of aqueous polymer dispersions. In these dispersions, the dispersed polymer particles are stabilised in a pH range of approx. pH 12 by anionic resin soaps such as abietic acid. Stabilisation is performed by electrostatic charge carriers in the form of negatively charged carboxylate groups of the resin soaps. The carboxylate groups of this emulsifier system are protonated by lowering the pH value to pH 8.5-9.5 and thus destabilising the dispersion sufficiently for slight mechanical shearing forces to be able to break up the dispersion. The pH value is lowered by the addition of an activator, which is mostly an acid such as citric acid or carbon dioxide in the form of gaseous CO₂. This produces a very swift initial adhesion that is not achieved by the pure evaporation of the water in the adhesive formulation. This property can be put to practical use by shearing the destabilised dispersion e.g. in spraying tasks, so that it breaks up when it comes into contact with the substrate, consequently forms larger sticky coagulate particles and thus forms an adhesive film on the substrate surface without any further evaporation of water.

However the shear sensitivity harbours the problem that the destabilised adhesives can only be delivered very carefully in a spray gun if coagulation of the adhesive in the spray gun is to be avoided. In addition, a number of destabilised adhesives exhibit a low pot life which prevents easy cleaning of the spray gun once the adhesive has been activated by the catalyst. As a result, rapid agglutination of the application nozzles must be expected, rendering the spray gun useless.

Until now, efforts to address this problem have predominantly involved storing, transporting and delivering the adhesive in the spray gun in a stabilised state. The catalyst is then added to the spray jet outside the spray gun during the spraying process, only shortly before the adhesive comes into contact with the substrate. The disadvantages of this method are on the one hand that the addition of the catalyst is rather uncontrolled, leaving free catalyst in the ambient air and overspray. This can be a problem for environmental, health and economic reasons. Furthermore, agglutination of the nozzle tip may still occur.

The invention is based on the task of providing a spray gun that overcomes the aforementioned disadvantages and with which an activator, a catalyst or another liquid or gaseous fluid is added in a controlled manner.

### THE INVENTION AND ITS ADVANTAGES

The task is solved by the spray gun according to the invention, as per claim 1. To that end the spray gun, which contains a gun housing, an application nozzle on the gun housing and a mixing system for combining the two components of a dual component medium, is equipped with a material channel in the gun housing to lead the first component into the mixing system. The material channel may be supplied from a reservoir located within the spray gun or outside the spray gun. Cartridges that are inserted in the gun housing are suitable reservoirs. Containers arranged next to the gun housing may also be used. The reservoir is usually connected detachably to the other assembly parts of the spray gun. It may be connected to the material channel via lines such as hoses, pipes or ducts in the housing. The first component may be delivered by the application of pressure from a manually, electrically, hydraulically or pneumatically driven system.

The spray gun is in addition equipped with a needle shut-off mechanism sliding along its longitudinal axis and guided in the gun housing, with at least one reagent channel to introduce the second component into the mixing system and/or into the material channel and at least one outlet opening of the reagent channel located away from the longitudinal axis of the needle shut-off mechanism, to release the second component from the reagent channel. This means that the at least one reagent channel leads into the at least one outlet opening that runs transversely with respect to the longitudinal axis and releases the second component out the needle shut-off mechanism around its circumference. The reagent channel at least in part does not run parallel to the longitudinal axis. The at least one outlet opening is thus located away from the longitudinal axis of the needle shut-off mechanism. The reagent channel is normally fed with the second component from a supply. The second component may be put under pressure by a pressurisation device for its delivery. If the second component is a gaseous fluid, the supply may take the form of a pressurised container. The supply may be connected to the reagent channel via lines such as pipes, hoses or channels in the housing. The outlet opening may exhibit a variety of shapes, including the shape of a slot. It is possible that there may be two or more outlet openings arranged on the needle shut-off mechanism. These may for example extend in a radial pattern around the needle shut-off mechanism. However it is equally conceivable for the outlet openings to extend around an area of one-third to one-half of the circumference of the needle shut-off mechanism.

At least one control device on the spray gun serves to slide the needle shut-off mechanism inside the gun housing. Examples of a manual control device are switches, buttons, knobs, sensors or the trigger of the spray gun. When the needle shut-off mechanism is slid by actuating the control device, the distance over which the needle shut-off mechanism slides may for example be in linear relation to the pressing distance of a switch or the pivoting distance of a trigger. It is also possible to actuate the control device automatically, for example by means of an electronic control. This may be desirable in particular if the spray gun is connected to an automated system for the application of the dual component medium.

At least one metering device is provided on the spray gun to alter the cross-section of the aperture of the at least one outlet opening of the needle shut-off mechanism by guiding the needle shut-off mechanism along a fixed cover in the housing when the needle shut-off mechanism is slid. This may for example take the form of a plate-like assembly part. The cover may also comprise several individual cover elements that are in a fixed arrangement in the housing. These may in turn be assigned to several outlet openings. However a cover in the form of a hollow cylinder which surrounds the needle shut-off mechanism around its full circumference if necessary and partly covers the needle shut-off mechanism along its longitudinal axis is advantageous. As a result of the interaction of the outlet opening and cover, the dimensions of the at least one outlet opening are altered. As a result, the volume of the second component supplied to the material channel and/or the mixing system can be regulated. This is also especially advantageous in that it avoids the premixing of a larger quantity of dual component medium than is actually required for a spraying operation.

According to an advantageous embodiment of the invention, the mixing system is a static mixer. The static mixer may be made from metal, plastic or other materials. The static mixer normally consists of a mixing tube with non-moving mixer elements arranged inside it, to blend the two components into a homogenous mass. Inside the tubular body of the mixer, the mixer elements may run continuously along a thread on the outside of a cylindrical wall in a helical pattern. Instead of the mixing tube, the mixer elements may also be surrounded by parts of the gun housing. Intensive blending of the components to be mixed is achieved by passing the two components over the thread of the static mixer.

According to a further advantageous embodiment of the invention, the mixing system constitutes the cover. In particular with a static mixer with a cylindrical element which has a thread on its outside, it is advantageous if the cylindrical element takes the form of a hollow cylinder that partly covers the longitudinal axis of the needle shut-off mechanism.

According to a further advantageous embodiment of the invention, the needle shut-off mechanism exhibits a stage with a seat area for engaging in a section of the application nozzle that has the shape of a needle seat. Around the seat area, the geometries of the needle shut-off mechanism and needle seat are at least in part of matching shapes. The needle seat may at least in part comprise a hollow cylinder. A conical needle seat tapering towards the opening of the application nozzle and a bush-shaped or concave needle seat are also conceivable. The seat area of the needle shut-off mechanism correspondingly takes the form, at least in part, of a cylindrical tappet, especially a circular cylinder, or exhibits convex designs, for example dished, spherical or conical. A very good sealing effect is achieved thanks to a precision fit. The sealing effect may be further improved by a suitable sealing material on the interfaces between the needle seat and seat area. The needle shut-off mechanism has no outlet openings in the seat area. The needle shut-off mechanism is closed at the end facing the application nozzle. If the seat area of the needle shut-off mechanism and the needle seat of the application nozzle are engaged in each other, the opening of the application nozzle is closed as a result and no material is discharged from the spray gun. With a needle shut-off mechanism with an overall length of 10 cm, the section including the seat area may be between 1 cm and 3 cm long, but preferably between 1.7 and 2.3 cm, and most preferably 2 cm. The seat area and needle seat may each have dimensions upwards of 1 mm in length. The at least one outlet opening is located in a second section of the needle shut-off mechanism, which directly or indirectly adjoins the section with the seat area. The second section of a needle shut-off mechanism with an overall length of 10 cm may be between 7 and 9 cm long, but preferably between 7.7 and 8.3 cm, and most preferably 8 cm. In a preferred embodiment, the at least one outlet opening is arranged directly adjoining the first section exhibiting the seat area.

According to a further advantageous embodiment of the invention, the needle shut-off mechanism exhibits at least one rest position, in which the seat area of the needle shut-off mechanism engages in the needle seat of the application nozzle and the outlet opening of the reagent channel is fully covered by the cover. If the spray gun is equipped with a manual control device, the control device is in its starting position. With an automatic control device, this is analogously in an initial state. The manual control device can spring back into this initial position when released by the user, for example after a spraying process has been ended. At the same time the needle shut-off mechanism is likewise brought back into the rest position by the returning forces of a suitable mechanism.

According to a further advantageous embodiment of the invention, the needle shut-off mechanism exhibits at least one cleaning position, in which the seat area of the needle shut-off mechanism is moved out of the needle seat and the at least one outlet opening is fully covered by the cover. The seat area of the needle shut-off mechanism is drawn out of the needle seat when the control device is actuated. This allows the first component to flow into the mixing system from the material channel and then out of the spray gun via the application nozzle. During this process the needle shut-off mechanism is guided along the cover in such a way that the at least one outlet opening is constantly covered. To that end, the travel of a trigger or switch from the rest position to a pressure point can be used as the switching travel. In the cleaning position, only the first component flows through the assembly parts of the spray gun. This ensures that the finished dual component medium, which has been activated and is more reactive than the first component, does not flow through it. If the needle shut-off mechanism is then brought into the rest position, the spray gun can for example be set down between two spraying processes without fear of the assembly parts becoming immediately blocked, since all assembly parts through which dual component medium flows in a spraying process contain only the first component. It is advantageous here that the first component is sealed off from the ambient air, with the result that the first component cannot react with components in the ambient air either, as necessary. If the component is a material whose properties are not or only marginally changed without the second component, the spray gun can be left for longer between spraying tasks without negatively impacting passage through the assembly parts. It is especially advantageous here that it is now not necessary to exchange assembly parts that have already been used in a spraying process for new, unused parts before a further spraying process.

According to a further advantageous embodiment of the invention, the needle shut-off mechanism exhibits at least one working position, in which the seat area of the needle shut-off mechanism is moved out of the needle seat by sliding the needle shut-off mechanism and the outlet opening is fully or partly exposed by the cover. Here, the needle shut-off mechanism is displaced further away from the needle seat of the application nozzle than when it is slid out of the rest position into a cleaning position. The extent to which the at least one outlet opening is exposed depends on the displacement distance of the needle shut-off mechanism, with the dimension of the cross-section of the opening of the at least one outlet opening usually increasing along with the distance between the needle shut-off mechanism and the needle seat. To change the dimension of the at least one outlet opening, the travel of a trigger or switch from a pressure point to a stop point for example can be used as the switching travel.

According to a further advantageous embodiment of the invention, the reagent channel can be shut off from a supply of the second component by at least one shutoff device. As a result the second component can be prevented from flowing through hoses which connect the supply to the reagent duct. The at least one shutoff device can be linked to the control device. It is possible that the shutoff device prevents a flow of the second component until a pressure point of a switch or trigger is exceeded. If the control device is moved beyond that point, the shutoff device exposes the flow of the second component.

According to a further advantageous embodiment of the invention, the shutoff device is a check valve. The second component in the reagent channel flows through the opened check valve through the at least one outlet opening and into the material channel and/or mixing system.

A further subject of the invention is the use of the spray gun according to the invention for the application of an adhesive obtained as the reaction product of a first and a second component. The spray gun is especially suitable for the targeted application of adhesive to surfaces to be bonded, especially in trade businesses and industry. Adhesives can be applied in a single pass over the full surface of a workpiece to be coated, but also in stripes, loops, wavy lines or dots. The first and second components are mixed inside the spray gun in the mixing system and the resulting medium is applied to the workpiece via an application nozzle.

According to an advantageous embodiment of the invention, the spray gun according to the invention is used to apply water-based adhesives. The spray gun according to the invention is naturally also suitable for use for other sprayable media that should or may only be mixed together at the time of application. However for environmental and health reasons in particular, it is advantageous to use the spray gun according to the invention for the application of water-based adhesives.

According to an advantageous embodiment of the invention, the spray gun according to the invention is used to apply water-based adhesives, where the first component is a polychloroprene dispersion. Chloroprene dispersions represent a particularly suitable category of aqueous polymer dispersions. In these dispersions, the dispersed polymer particles are stabilised in a pH range of approx. pH 12 by anionic resin soaps. This emulsifier system can be sufficiently stabilised by lowering the pH value to pH 8.5-9.5 for slight mechanical shearing forces to be sufficient to break up the dispersion.

According to an advantageous embodiment of the invention, the spray gun according to the invention is used to apply adhesives, where the second component is an activator. The scope for metered addition of an activator or a catalyst in a controlled manner achieves an optimum mixing ratio of the first and second component. This also prevents free activator or catalyst from being present in the overspray from the spraying process.

According to an advantageous embodiment of the invention, the spray gun according to the invention is used to apply adhesives, where the second component is CO₂. CO₂ may take on the function of an activator or catalyst here. In particular when used in combination with an aqueous polychloroprene dispersion, the metered addition of CO₂ prompts the destabilisation of the dispersion by lowering the pH value and thus the formation of an adhesive which is applied with a high initial adhesion to the workpiece to be bonded.

According to a further advantageous embodiment of the invention, the spray gun according to the invention is used for bonding foams in mattress and furniture/upholstery bonding.

Further advantages and advantageous embodiments of the invention can be obtained from the following description, the drawing and the claims.

### DRAWING

The drawing shows a model embodiment of the spray gun according to the invention. Illustration:

FIG. 1: Schematic longitudinal section through the part of a spray gun in the rest position exhibiting the application nozzle and needle shut-off mechanism, with the needle shut-off mechanism represented in a side view.

FIG. 2: Schematic longitudinal section through the spray gun according to FIG. 1 in the working position, with the longitudinal section of the needle shut-off mechanism shown.

### DESCRIPTION OF THE MODEL EMBODIMENT

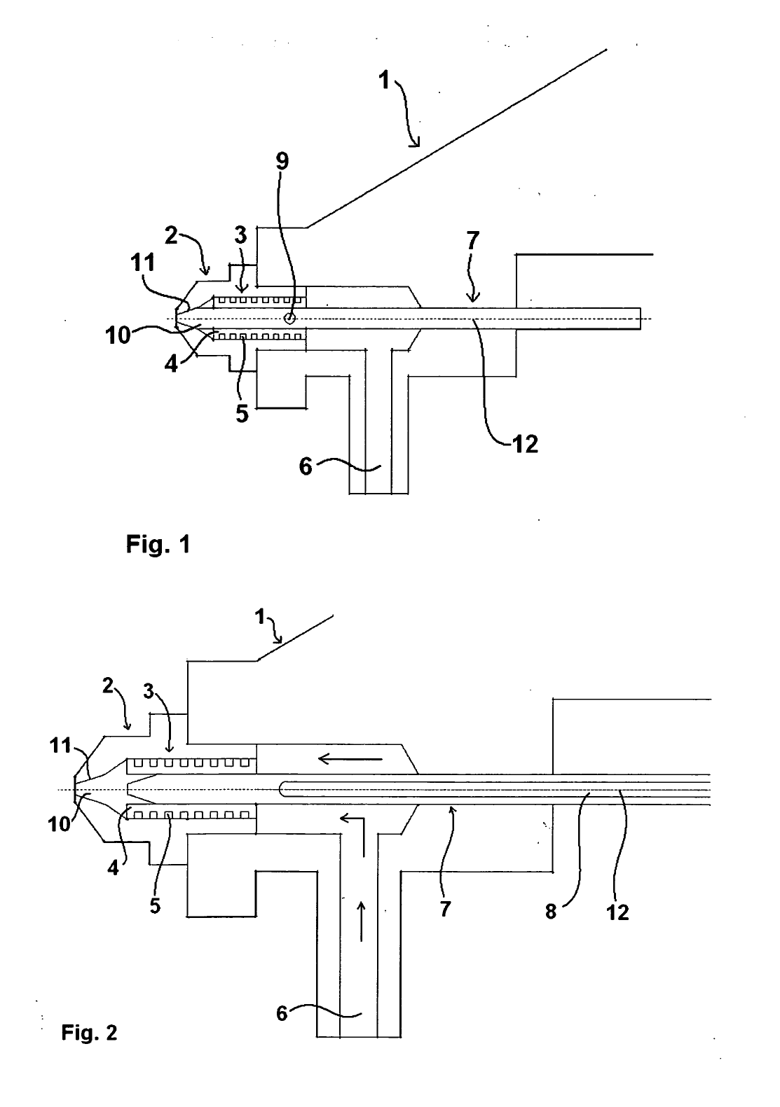

A spray gun for the application of dual component media is shown in the rest position in FIG. 1. Reservoirs, supplies and similar for the first and second component, as well as the hoses, ducts and pipes arranged in the gun housing 1, are not represented. FIG. 1 shows the gun housing 1 of the spray gun with an application nozzle 2 arranged on the gun housing 1. A mixing system 3 taking the form of a static mixer serves to blend the components. The mixing system 3 contains a cylinder 4, which takes the form of a hollow cylinder, with a profiled groove 5 that runs continuously in a spiral around the outside wall of the cylinder 4 and serves as a mixing chamber for the components to be mixed. A material channel 6 in the gun housing 1 is connected to the profiled groove 5 and serves to lead the first component into the mixing system. A needle shut-off mechanism 7 sliding along its longitudinal axis and guided in the gun housing 1 is equipped with at least one reagent channel 8 to lead the second component into the material channel. The reagent channel 8 is illustrated in FIG. 2. FIG. 1 shows an outlet opening 9 of the needle shut-off mechanism 7, which serves to release the second component from the reagent channel 8. The needle shut-off mechanism 7 with a seat area 10 engages in a needle seat 11 of the application nozzle 2. This closes up the application nozzle 2. In addition, the needle shut-off mechanism is introduced part-way into the hollow cylinder 4 of the mixing system 3. As a result the outlet opening 9 of the needle shut-off mechanism 7 is fully covered by the cylinder 4 that serves as the cover. The outlet opening 9 is thus likewise closed. Consequently there is no flow of a second component.

The flow of the first component is interrupted by the application nozzle 2 being closed by the needle shut-off mechanism 7. The needle shut-off mechanism 7 thus performs the function of stopping up both the spray gun and the supply as well as, in conjunction with a cover, the metering of the second component.

A spray gun according to the invention for the application of dual component media is shown in the working position in FIG. 2. FIG. 2 differs from FIG. 1 in that the needle shut-off mechanism 7 with its seat area 10 is moved out of the needle seat 11 of the application nozzle 2. The arrows shown in the material channel 6 depict the direction of flow of the second component in the material channel 6. At the same time, in contrast to FIG. 1 the outlet opening 9 of the reagent channel 8 is open in FIG. 2, releasing the second component into the material channel 6. The outlet opening 9 is not shown in FIG. 2; it is shown in FIG. 1. In the spray gun's working position, both components are led from the material channel 6 into the mixing system 3 with the profiled groove 5. A connection between the profiled groove 5 of the mixing system 3 with the application nozzle 2 serves to lead the dual component medium into the application nozzle 2 after blending of the components. The dual component medium is applied by the application nozzle p to the workpiece to be bonded.

To proceed from the rest position shown in FIG. 1 to the working position represented in FIG. 2, the needle shut-off mechanism 7 in the gun housing 1 is drawn out of the needle seat 11 of the application nozzle 2 along its longitudinal axis 12. In the process the needle shut-off mechanism 7 is guided along the inner wall of the hollow cylinder 4, which is fixed inside the gun housing 1 as a part of the mixing system 3.

All features of the invention can be material to the invention both individually and in any combination.

### REFERENCE NUMBERS

1 Gun housing
2 Application nozzle
3 Mixing system
4 Cylinder
5 Profiled groove
6 Material channel
7 Needle shut-off mechanism
8 Reagent channel
9 Outlet opening
10 Seat area
11 Needle seat
12 Longitudinal axis of the needle shut-off mechanism

1. Spray gun for the application of dual component media,
with a gun housing (1),
with an application nozzle (2) on the gun housing (1),
with a mixing system (3) in the gun housing for combining the components,
with a material channel (6) in the gun housing (1) for introducing the first component into the mixing system (3), with a needle shut-off mechanism (7) sliding along its longitudinal axis and guided in the gun housing (1),
with at least one reagent channel (8) in the needle shut-off mechanism (7) to introduce the second component into the mixing system (3) and/or into the material channel (6),
with at least one outlet opening (9) arranged in the reagent channel (8) away from the longitudinal axis of the needle shut-off mechanism to release the second component from the reagent channel (8),
with at least one control device on the spray gun to slide the needle shut-off mechanism (7) inside the gun housing (1), with at least one metering device on the spray gun to alter the cross-section of the aperture of the at least one outlet opening (9) of the needle shut-off mechanism (7) by guiding the needle shut-off mechanism (7) along a fixed cover in the housing (1) when the needle shut-off mechanism (7) is slid.

2. Spray gun according to claim 1, wherein the mixing system (3) is a static mixer.

3. Spray gun according to claim 1, wherein the mixing system exhibits the cover.

4. Spray gun according to claim 1, wherein the needle shut-off mechanism exhibits a section with a seat area (10) for engaging in an area of the application nozzle (2) that has the shape of a needle seat (11).

5. Spray gun according to claim 4, wherein the needle shut-off mechanism (7) exhibits at least one rest position in which the seat area (10) of the needle shut-off mechanism (7) engages in the needle seat (11) of the application nozzle (2) and the outlet opening (9) is fully covered by the cover.

6. Spray gun according to claim 4, wherein the needle shut-off mechanism (7) exhibits at least one cleaning position in which the seat area (10) of the needle shut-off mechanism (7) is moved out of the needle seat (11) and the at least one outlet opening (9) is fully covered by the cover.

7. Spray gun according to claim 4, wherein the needle shut-off mechanism (7) exhibits at least one working position in which the seat area (10) of the needle shut-off mechanism (7) is moved out of the needle seat (11) by sliding of the needle shut-off mechanism (7) and the outlet opening (9) is fully or partly exposed by the cover.

8. Spray gun according to claim 1, wherein the reagent channel (8) can be shut off from a supply of the second component by at least one shutoff device.

9. Spray gun according to claim 8, wherein the shutoff device is a check valve.

10. Use of a spray gun in accordance with claim 1 for the application of an adhesive obtained as the reaction product of a first and a second component.

11. Use of a spray gun according to claim 10, where the adhesive is a water-based adhesive.

12. Use of a spray gun according to claim 11, where the first component is a polychloroprene dispersion.

13. Use of a spray gun according to claim 10, where the second component is an activator.

14. Use of a spray gun according to claim 10, where the second component is CO₂.

15. Use of a spray gun according to claim 10 for bonding foams in mattress and furniture/upholstery bonding.
